(19) United States
(12) Patent Application Publication
(10) Pub. No.: US 2026/0118480 A1
(43) Pub. Date: Apr. 30, 2026

(54) METHOD AND APPARATUS FOR CLUSTERING POINT CLOUD DATA OF LIGHT DETECTION AND RANGING

(71) Applicant: Foundation for Research and Business, Seoul National University of Science and Technology, Seoul (KR)

(72) Inventors: Seung Eun LEE, Seoul (KR); Sangho LEE, Seoul (KR); Seongmo AN, Seoul (KR)

(73) Assignee: Foundation for Research and Business, Seoul National University of Science and Technology, Seoul (KR)

(21) Appl. No.: 19/372,347

(22) Filed: Oct. 29, 2025

(30) Foreign Application Priority Data
Oct. 30, 2024 (KR) 10-2024-0151382

(51) Int. Cl. G01S 7/48; G01S 17/06; G06T 7/70

(52) U.S. Cl. CPC G01S 7/4802; G01S 17/06; G06T 7/70; G06T 2207/10028

(57) ABSTRACT

A method and apparatus for clustering point cloud data of a light detection and ranging (LiDAR) are provided. The method includes obtaining point cloud data of a LiDAR, assigning a grid-based index to each of points included in the point cloud data, and performing density-based clustering on the point cloud data based on the grid-based index.

### RELATED APPLICATIONS

This application claims the benefit of priority of Korean Patent Application No. 10-2024-0151382, filed on October 30, 2024, the contents of which are all incorporated by reference as if fully set forth herein in their entirety.

### FIELD AND BACKGROUND OF THE INVENTION

### 1. Field of the Invention

The present disclosure relates to a method and apparatus for clustering point cloud data of a light detection and ranging (LiDAR), and more particularly, to a method and apparatus for reducing computational complexity of clustering point cloud data of a LiDAR.

### 2. Description of the Related Art

A light detection and ranging (LiDAR) sensor, one of sensors used in vehicles, recognizes a surrounding environment in three dimensions based on point cloud data obtained through light and plans a driving path of a vehicle.

The point cloud data obtained from the LiDAR sensor recognizes objects through advanced clustering technology, and accordingly, an autonomous vehicle performs safe and efficient autonomous driving by avoiding obstacles that may be dangerous while driving.

In a conventional method of clustering point cloud data of a LiDAR, a distance between an arbitrary center point and other points included in the point cloud data is measured, and when the number of points within a predetermined distance from the center point exceeds a predetermined number, groups are formed with the points within the predetermined distance from the center point. However, in order to identify a point within the predetermined distance from the center point, a distance between a single point included in the point cloud data and all points except the corresponding point needs to be calculated, and thus, "N²" operations need to be performed on "N" pieces of data, resulting in high computational complexity required for clustering.

As an algorithm becomes more computationally complex, it will require more powerful hardware to complete computations, and thus, a method of reducing the computational complexity compared to conventional clustering methods is requested.

### SUMMARY OF THE INVENTION

The present disclosure provides a method and apparatus for reducing computational complexity compared to a conventional clustering method of performing clustering by measuring a distance between all points included in point cloud data and a center point, by assigning a grid-based index to each point included in the point cloud data, identifying eight points adjacent to the center point according to the grid-based index, and performing clustering by measuring only a distance between the identified points and the center point.

According to an aspect, there is provided a clustering method including obtaining point cloud data of a light detection and ranging (LiDAR), assigning a grid-based index to each of points included in the point cloud data, and performing density-based clustering on the point cloud data based on the grid-based index.

The performing of the density-based clustering may include selecting an arbitrary center point from among the points included in the point cloud data, identifying eight points adjacent to the arbitrary center point by using the grid-based index, measuring a distance between the arbitrary center point and each of the eight points, identifying a number of points among the eight points in which the measured distance is less than or equal to a threshold distance, when the identified number of points exceeds a threshold number, forming a group

including points in which the distance is less than or equal to the threshold distance and the arbitrary center point, and clustering an inner portion of the group.

The performing of the density-based clustering may further include, when the identified number of points is less than or equal to the threshold number, selecting another point as an arbitrary center point from among the points included in the point cloud data.

The performing of the density-based clustering may further include confirming whether the center point included in the group is also included in another group and when the center point included in the group is also included in the other group, merging the group with the other group.

According to an aspect, there is provided a clustering apparatus including an inputter configured to obtain point cloud data of a LiDAR and a processor configured to assign a grid-based index to each of points included in the point cloud data and perform density-based clustering on the point cloud data based on the grid-based index.

Additional aspects of embodiments will be set forth in part in the description which follows and, in part, will be apparent from the description, or may be learned by practice of the disclosure.

According to embodiments, computational complexity may be reduced compared to a conventional clustering method of performing clustering by measuring a distance between all points included in point cloud data and a center point, by assigning a grid-based index to each point included in the point cloud data, identifying eight points adjacent to the center point according to the grid-based index, and performing clustering by measuring only a distance between the identified points and the center point.

### BRIEF DESCRIPTION OF THE SEVERAL VIEWS OF THE DRAWING(S)

These and/or other aspects, features, and advantages of the invention will become apparent and more readily appreciated from the following description of embodiments, taken in conjunction with the accompanying drawings of which:

FIG. 1 is a diagram illustrating a clustering apparatus according to an embodiment;

FIG. 2 illustrates an example of a hardware configuration of a clustering apparatus, according to an embodiment;

FIG. 3 illustrates an example of a clustering process according to an embodiment;

FIG. 4 illustrates an example of a range of a LiDAR used in an embodiment of the present disclosure, which emits light;

FIG. 5 illustrates an example of a process of assigning a grid-based index, according to an embodiment;

FIG. 6 illustrates an example of a clustering accelerator according to an embodiment;

FIG. 7 illustrates an example of a clustering result according to an embodiment;

FIG. 8 is a flowchart illustrating a clustering method of point cloud data of a LiDAR, according to an embodiment;

FIG. 9 is a flowchart illustrating a density-based clustering process using a grid of FIG. 8; and

FIG. 10 is a flowchart illustrating a process of clustering an inner portion of a group in FIG. 9.

### DESCRIPTION OF SPECIFIC EMBODIMENTS OF THE INVENTION

Hereinafter, embodiments will be described in detail with reference to the accompanying drawings. However, various alterations and modifications may be made to the embodiments, and thus, the embodiments are not construed as limiting the scope of the rights

of the patent application. The embodiments should be understood to include all changes, equivalents, and replacements within the idea and the technical scope of the disclosure.

The terminology used herein is for the purpose of describing particular embodiments only and is not to be limiting of the embodiments. The singular forms "a", "an", and "the" are intended to include the plural forms as well, unless the context clearly indicates otherwise. It will be further understood that the terms "comprises/comprising" and/or "includes/including" when used herein, specify the presence of stated features, integers, steps, operations, elements, and/or components, but do not preclude the presence or addition of one or more other features, integers, steps, operations, elements, components and/or groups thereof.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

Hereinafter, embodiments are described in detail with reference to the accompanying drawings.

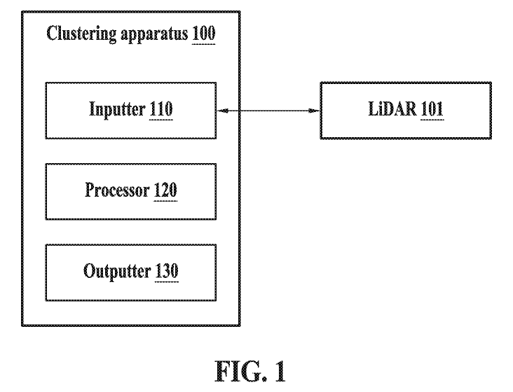

FIG. 1 is a diagram illustrating a clustering apparatus according to an embodiment.

A clustering apparatus 100 according to an embodiment of the present disclosure may include an inputter 110, a processor 120, and an outputter 130, as shown in FIG. 1.

The inputter 110 may receive point cloud data generated by measurement from a light detection and ranging (LiDAR) 101 through wired or wireless communication. The inputter 110 may transmit the received point cloud data to the processor 120.

The processor 120 may assign a grid-based index to each point included in the point cloud data. In addition, the processor 120 may perform density-based clustering on the point cloud data based on the grid-based index.

Specifically, the processor 120 may select an arbitrary center point from among points included in the point cloud data. Next, the processor 120 may identify eight points adjacent to the arbitrary center point by using the grid-based index.

Next, the processor 120 may measure a distance between the arbitrary center point and each of the eight points. Next, the processor 120 may identify the number of points among the eight points in which the measured distance is less than or equal to a threshold distance.

When the identified number of points is less than or equal to a threshold number, the processor 120 may select another point as an arbitrary center point, from among the points included in the point cloud data. In addition, the processor 120 may repeat the above process for all points included in a frame of the point cloud data.

When the identified number of points exceeds the threshold number, the processor 120 may form a group including the points in which the distance is less than or equal to the threshold distance and the arbitrary center point.

Here, the processor 120 may confirm whether the center point included in the group is also included in another group. When the center point included in the group is also included in the other group, the processor 120 may merge the group with the other group.

In addition, the processor 120 may cluster an inner portion of the formed group.

Here, the processor 120 may select, as the center point, one of points included in the group in which the distance is less than or equal to the threshold distance. The processor 120 may identify eight points adjacent to the center point by using the grid-based index. The processor 120 may measure the distance between the center point and each of the eight points. The processor 120 may identify the number of points among the eight points in which the measured distance is less than or equal to the threshold distance. When the identified number of points exceeds the threshold number, the processor 120 may form a subgroup including the points in which the distance is less than or equal to the threshold distance and the center point.

When the center point included in the subgroup is included in another subgroup, the processor 120 may merge the subgroup with the other subgroup. When the center point included in the subgroup is not included in another subgroup, the processor 120 may repeatedly perform a process of selecting a point, as the center point, that has not been selected as the center point, for all points included in the group in which the distance is less than or equal to the threshold distance.

The outputter 130 may output a result of density-based clustering performed by the processor 120. For example, the outputter 130 may be a display that displays the result of density-based clustering, a device (e.g., a personal computer (PC)) that performs machine learning using the result of density-based clustering, or a communication device that transmits the result of density-based clustering to an autonomous driving system.

The clustering apparatus 100 may assign the grid-based index to each of the points included in the point cloud data, may identify the eight points adjacent to the center point according to the grid-based index, and may perform clustering by measuring only the distance between the identified points and the center point, thereby reducing computational complexity compared to a conventional clustering method of performing clustering by measuring the distance between all points included in the point cloud data and the center point.

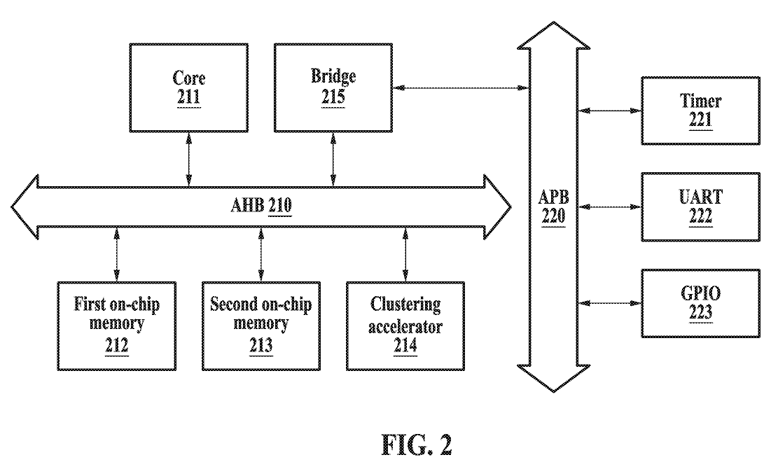

FIG. 2 illustrates an example of a hardware configuration of a clustering apparatus, according to an embodiment.

The clustering apparatus 100 may be configured based on an advanced high-performance bus (AHB) 210 and an advanced peripheral bus (APB) 220.

The AHB 210 may be connected to modules that require a high-speed bus interface for data transmission, such as a core 211, a first on-chip memory 212, a second on-chip memory 213, and a clustering accelerator 214. The APB 220 may be connected to peripheral modules that do not require high-speed data communication, such as a timer 221, a universal asynchronous receiver transmitter (UART) 222, and a general-purpose input/output (GPIO) 223. An AHB-APB bridge 215 may change a bus signal to facilitate communication between the AHB 210 and the APB 220. The processor 120, shown in FIG. 1, may correspond to the core 211 and the clustering accelerator 214 of FIG. 2. In addition, the inputter 110 and a communicator may correspond to the UART 222 of FIG. 2.

The core 211 may function as a master of the AHB 210 and may access each module through an address assigned to each of the peripheral devices and modules. In addition, the core 211 may read and execute instructions imported from the first on-chip memory 212 and the second on-chip memory 213 to control the modules. For example, the core 211 may be Cortex-M0, which is a low-power core.

The first on-chip memory 212 and the second on-chip memory 213 may be sections that store different types of data in a single on-chip memory. Specifically, the first on-chip memory 212 may be a section that stores instruction code required for program execution, and the second on-chip memory 213 may be a section that stores data required while executing codes in the core 211.

For example, a bit stream compiled in Keil uVision 5 into C code to execute the Cortex-M0 may be stored in the first on-chip memory 212. In addition, x, y, and z coordinate data and a sorted pixel list (defined as a seed list) for clustering the x, y, and z coordinate data may be stored in the second on-chip memory 213 and may be transmitted to a register array of the clustering accelerator 214.

When a start signal is generated after the storage of the seed list is completed, the clustering accelerator 214 may cluster points included in a frame of point cloud data by using data stored in the register array. In addition, when the clustering is completed, the clustering accelerator 214 may transmit group information generated according to the clustering to a PC via the UART 222. For example, the clustering accelerator 214 may be a density-based spatial clustering of applications with a noise (DBSCAN) clustering accelerator.

The timer 221 may provide time information to components included in the clustering apparatus 100.

The UART 222 may communicate with the PC to transmit a point cloud data set for clustering to the register array of the clustering accelerator 214.

When clustering is completed for all frames, clustering data stored in the register array may be transmitted to the PC via the UART 222.

The GPIO 223 may support communication with other sensors or motors and may be connected to additional modules to facilitate additional control based on clustered group data.

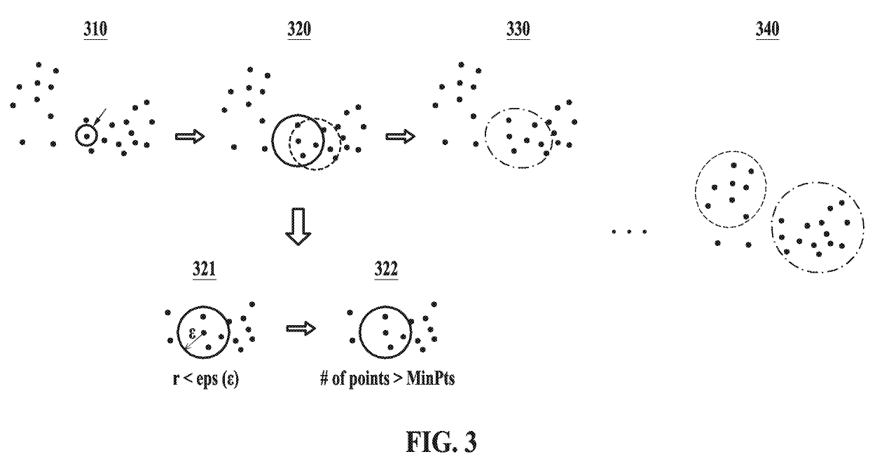

FIG. 3 illustrates an example of a clustering process according to an embodiment.

In operation 310, the processor 120 may select an arbitrary center point from among points included in point cloud data.

In operation 320, the processor 120 may identify eight points adjacent to the arbitrary center point by using the grid-based index.

In operation 321, the processor 120 may measure a distance between the arbitrary center point and each of the eight points.

In operation 322, the processor 120 may identify the number of points among the eight points in which the measured distance is less than or equal to a threshold distance.

When the identified number of points exceeds the threshold number, the processor 120 may form a group including the points in which the distance is less than or equal to the threshold distance and the arbitrary center point. Here, the processor 120 may confirm whether the center point included in the group is also included in another group. When the center point included in the group is also included in the other group, the processor 120 may perform operation 330.

In operation 330, the processor 120 may merge the group formed in operation 322 with another group to generate a single group.

In operation 340, the processor 120 may repeatedly perform operations 310 to 330 for all points included in a frame of the point cloud data to generate a plurality of groups as illustrated in FIG. 3.

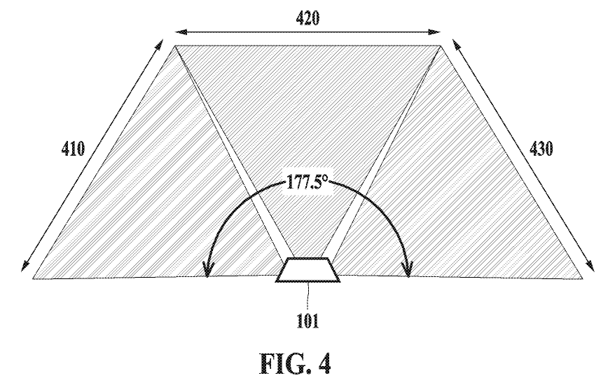

FIG. 4 illustrates an example of a range of a LiDAR used in an embodiment of the present disclosure, which emits light.

The LiDAR 101 may have a fixed position from which light is emitted, and the number of points measured per frame may also be fixed. For example, as shown in FIG. 4, a fixed LiDAR may emit light by dividing a left side 410 into "32" sections in a horizontal direction, may emit light by dividing a front side 420 into "32" sections in a horizontal direction, may emit light by dividing a right side 430 into "32" sections in a horizontal direction, and may receive reflected light from each direction to generate point cloud data. Here, each of points included in the point cloud data may correspond to light reflected from an object or background in each direction.

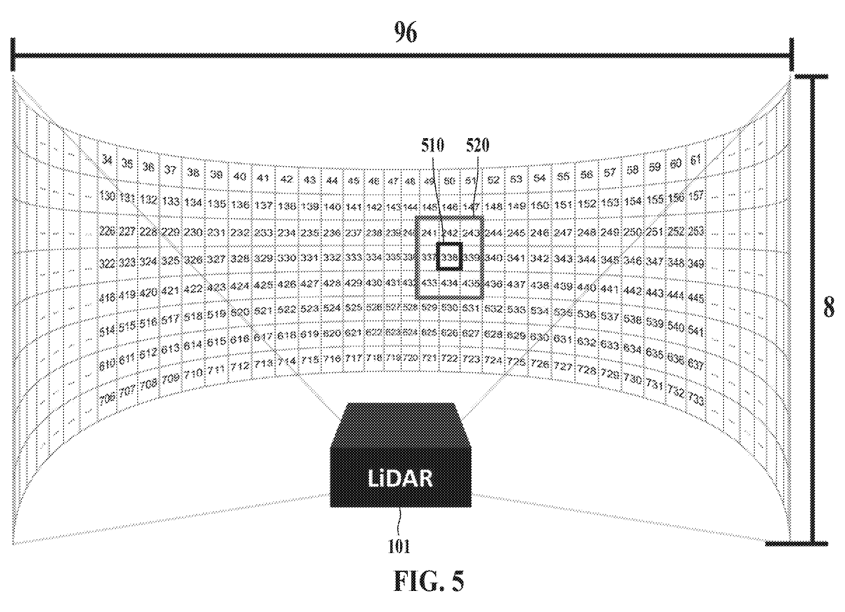

FIG. 5 illustrates an example of a process of assigning a grid-based index, according to an embodiment.

When the LiDAR 101 is a fixed LiDAR as shown in FIG. 4, the processor 120 may map a location in which light is emitted from the LiDAR 101 onto a two-dimensional grid. For example, when the LiDAR 101 is a Pixell LiDAR of LeddarTech, the Pixell of the LiDAR 101 may cover approximately 180 degrees and may emit light at "768" points distributed at "8" vertical positions and "96" horizontal positions to measure distances.

Accordingly, the processor 120 may assign a grid-based index to each of "768" pixels distributed at "8" vertical positions and "96" horizontal positions, as shown in FIG. 5. In addition, when a point 510 is selected as the center point during a clustering process, the processor 120 may identify eight points 520 as eight points adjacent to the center point according to the index. Here, the eight points 520 may be 241, 242, 243, 337, 339, 433, 434, and 435, as shown in FIG. 5.

In addition, the distance between the center point 510 and each of the eight points 520 measured by the processor 120 may be a distance based on the difference in depth value of each of the points relative to the LiDAR 101.

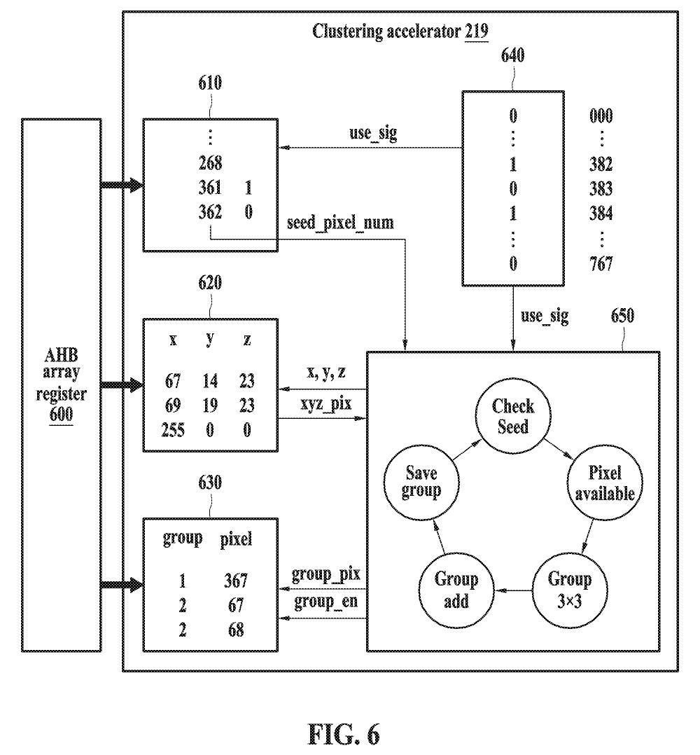

FIG. 6 illustrates an example of a clustering accelerator according to an embodiment.

The clustering accelerator 214 may include a seed list register array 610, an xyz-list register array 620, a group list register array 630, a pix-use register array 640, and a grouping core 650.

The pix-use register array 640 may include "768" 1-bit signals and may represent whether, during clustering of a frame, a pixel index has been included in a group (signaled as 1) or has not yet been clustered (signaled as 0).

The seed list register array 610 and the grouping core 650 may refer to the pix-use register array 640 to confirm whether seed pixels are already included in the group or whether new pixels to be stored are already a portion of another group.

The seed list register array 610 may store a seed list, which is an index order of pixels to be clustered. Here, the index order may prioritize pixels that are likely to form a group for each frame to facilitate clustering.

The seed list register array 610 sequentially provides the seed pixels when requested and may confirm whether the seed pixels are a portion of the group through the pix-use register array 640 before providing a seed pixel index to the grouping core 650.

The xyz-list register array 620 may store x, y, and z coordinate data corresponding to each index, and the x, y, and z coordinate data may each occupy "8" bits. When a signal with a specific pixel index is received, the xyz-list register array 620 may provide the x, y, and z coordinate data corresponding to the specific pixel index after one clock cycle.

When the group is completely formed, the group list register array 630 may receive a signal from the grouping core 650 and may sequentially store an index of the pixels included in the group.

When clustering for all pixels is completed, the grouping core 650 may send a frame-cplt signal to cause the group list register array 630 to transmit group information for the frame to the outside.

Therefore, each of the register arrays may store information for each pixel and may be connected to the grouping core 650 to support the clustering process.

The grouping core 650 may perform DBSCAN clustering based on point cloud data of a LiDAR.

The clustering process may include a seed-chk operation, a pix-avl operation, a group3x3 operation, a group-add operation, and a save-group operation that start after data is stored in the xyz-list register array 620 and the seed list register array 610.

In the seed-chk operation, the grouping core 650 may transmit a signal to the seed list register array 610 to obtain the seed pixel, and when seed searching is completed, the pix-avl operation may be performed.

In the pix-avl operation, the grouping core 650 may determine which pixels are core points, the seed pixels, or pos pixels. Here, the pos pixels may include pixels included in the formed group.

When x, y, z coordinates of a selected core pixel are not dummy data, neighboring pixels to be calculated may be applied to the group3x3 operation.

In the group3x3 operation, the grouping core 650 may calculate a distance from the core pixel (the center point 510) to a maximum of eight pixels (the eight points 520), as shown in FIG. 5, to confirm the number of points within eps and may compare the number of points to the number of pixels in group3x3 including the core pixel to confirm whether the number of pixels in group3x3 meets or exceeds MinPts, which is a threshold coefficient.

When the number is less than or equal to the threshold coefficient MinPts and no group is formed, the grouping core 650 may perform the seed-chk operation and may import the seed pixels as new core pixels.

When the number exceeds the threshold coefficient MinPts, the grouping core 650 may confirm whether the center point is included in another existing group. When the center point included in the group is also included in another existing group, the grouping core 650 may merge the center point with the other existing group. When the center point included in the group is not included in another existing group, the grouping core 650 may generate a new group.

When a process of adding a group is completed, the grouping core 650 may return to the pix-avl operation and may assign a pixel index of the pos-pixel group as the core pixel.

After the group is formed, when there are no pos pixels left for additional core pixel evaluation, the grouping core 650 may transition to a storage group operation in which the newly formed group is stored in a group list.

When the storage group operation is completed, the grouping core 650 may repeat the entire process until all pixels have undergone the clustering process. In addition, when the clustering is completed, a frame completion signal may be transmitted to the group list register array 630. Next, the group list stored in the group list register array 630 may be transmitted to the UART 222 according to the request of the core 211.

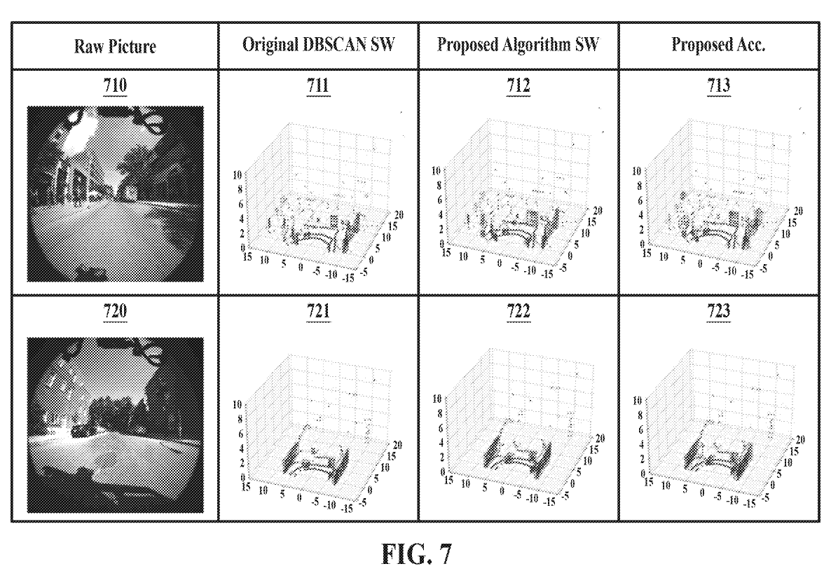

FIG. 7 illustrates an example of a clustering result according to an embodiment.

The following are examples of clustering results 711 and 721 of raw pictures 710 and 720 of a camera sensor included in Pixset each clustered using a conventional clustering algorithm, clustering results 712 and 722 by the clustering apparatus 100 including a standard core, and clustering results 713 and 723 by a clustering apparatus including a low-power core as shown in FIG. 2.

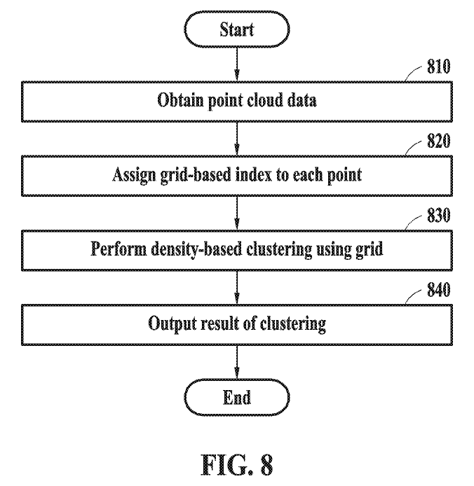

FIG. 8 is a flowchart illustrating a clustering method of point cloud data of a LiDAR, according to an embodiment.

In operation 810, the inputter 110 may receive point cloud data generated by measurement from a LiDAR 101 through wired or wireless communication. The inputter 110 may transmit the received point cloud data to the processor 120.

In operation 820, the processor 120 may assign a grid-based index to each point included in the point cloud data obtained in operation 810.

In operation 830, the processor 120 may perform density-based clustering on the point cloud data based on the grid-based index.

In operation 840, the outputter 130 may output a result of density-based clustering performed in operation 830. For example, the outputter 130 may display the result of density-based clustering on a display, may be a device (e.g., a PC) that performs machine learning using the result of density-based clustering, or may transmit the result of density-based clustering to an autonomous driving system.

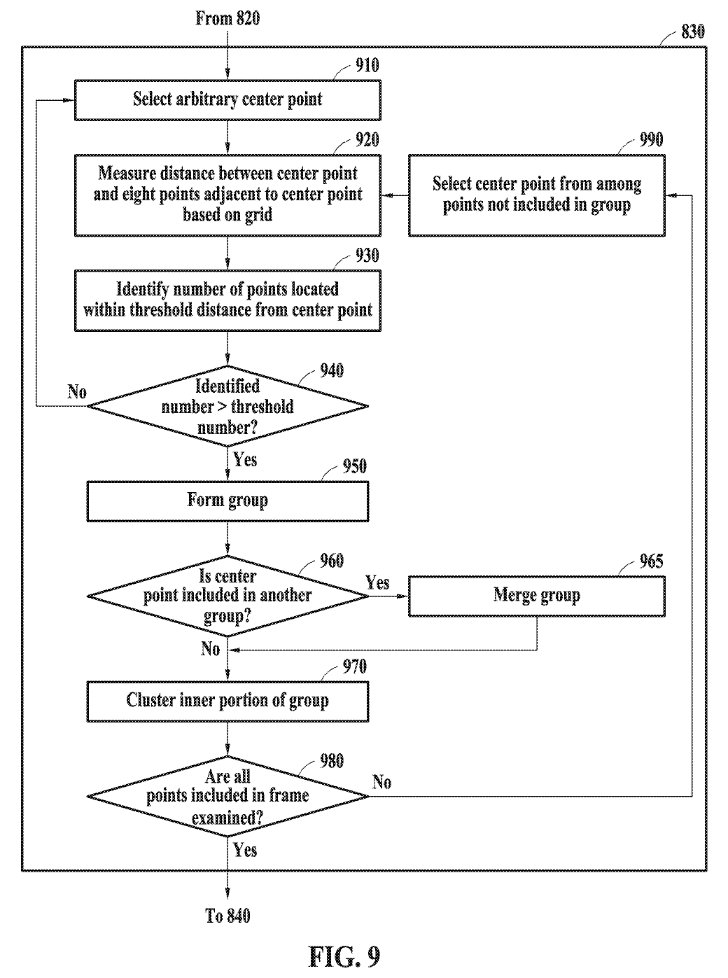

FIG. 9 is a flowchart illustrating a density-based clustering process using a grid of FIG. 8. Operations 910 to 990 of FIG. 9 may be included in operation 830 of FIG. 8.

In operation 910, the processor 120 may select an arbitrary center point from among points included in point cloud data.

In operation 920, the processor 120 may identify eight points adjacent to the arbitrary center point by using the grid-based index. In addition, the processor 120 may measure a distance between the arbitrary center point and each of the eight points.

In operation 930, the processor 120 may identify the number of points among the eight points, identified in operation 920, in which the measured distance is less than or equal to a threshold distance.

In operation 940, the processor 120 may confirm whether the number of points identified in operation 930 exceeds a threshold number. When the number of points identified in operation 930 exceeds the threshold number, the processor 120 may perform operation 950. When the identified number of points in operation 930 is less than or equal to the threshold number, the processor 120 may perform operation 910 again and may select another point as an arbitrary center point, from among the points included in the point cloud data.

In operation 950, the processor 120 may form a group including the points in which the distance is less than or equal to the threshold distance and the arbitrary center point.

In operation 960, the processor 120 may confirm whether the center point included in the group is also included in another group. When the center point included in the group is also included in the other group, the processor 120 may perform operation 965. When the center point included in the group is not included in the other group, the processor 120 may perform operation 970.

In operation 965, the processor 120 may merge the group formed in operation 960 with another group including the center point.

In operation 970, the processor 120 may cluster an inner portion of the group formed in operation 960.

In operation 980, the processor 120 may confirm whether all points included in a frame of the point cloud data have been examined. When all points included in the frame of the point cloud data are formed into a group or have a history of being selected as the center point, the processor 120 may determine that all points included in the frame of the point cloud data have been examined, may terminate the clustering operation, and may perform operation 840. When there is a point among the points included in the frame of the point cloud data that is not selected as the center point or is not formed into a group, the processor 120 may perform operation 990.

In operation 990, the processor 120 may select one point as an arbitrary center point from among the points included in the point cloud data but not included in the group formed in operation 960.

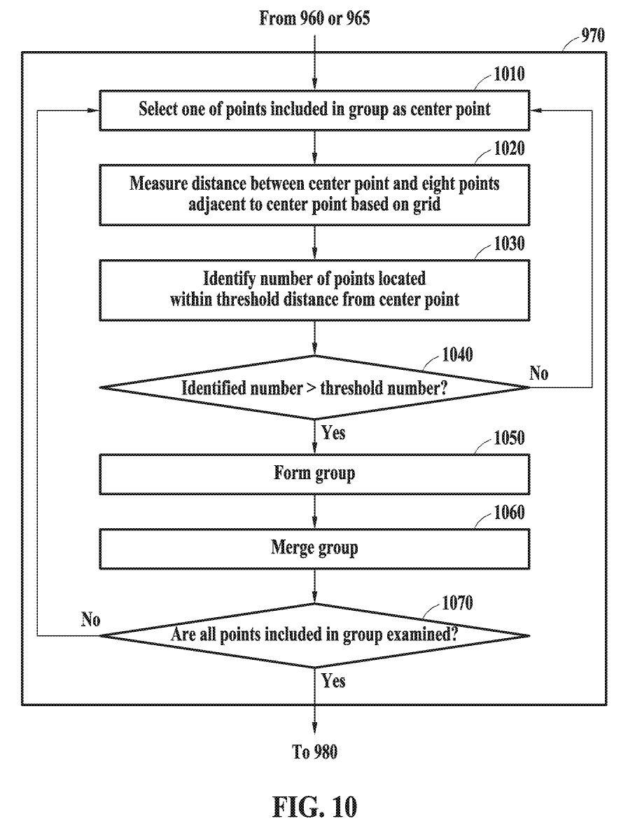

FIG. 10 is a flowchart illustrating a process of clustering an inner portion of a group in FIG. 9. Operations 1010 to 1070 of FIG. 10 may be included in operation 970 of FIG. 9.

In operation 1010, the processor 120 may select one of the points included in the group formed in operation 960 as the center point.

In operation 1020, the processor 120 may identify eight points adjacent to the center point by using a grid-based index. In addition, the processor 120 may measure the distance between the center point and each of the eight points.

In operation 1030, the processor 120 may identify the number of points among the eight points in which the measured distance is less than or equal to a threshold distance.

In operation 1040, the processor 120 may confirm whether the number of points identified in operation 1030 exceeds a threshold number. When the number of points identified in operation 1030 exceeds the threshold number, the processor 120 may perform operation 1050. When the number of points identified in operation 1030 is less than or equal to the threshold number, the processor 120 may perform operation 1010 again and may select a point, as the center point, that has not been selected as the center point from among the points included in the group.

In operation 1050, the processor 120 may form a subgroup including the points in which the distance is less than or equal to the threshold distance and the center point.

In operation 1060, the processor 120 may confirm whether the center point included in the subgroup is included in another subgroup, and when the center point included in the subgroup is included in another subgroup, the subgroup may be merged with the other subgroup. When the center point included in the subgroup is not included in another subgroup, the processor 120 may not perform a group merging process.

In operation 1070, the processor 120 may confirm whether all points included in the group have been examined. When all points included in the group are formed into a subgroup or have a history of being selected as the center point, the processor 120 may determine that all points included in the group have been examined and may perform operation 980. When there is a point among the points included in the group that is not selected as the center point or is not formed into a subgroup, the processor 120 may perform operation 1010. Here, the processor 120 may select one point as the center point from among the points that are included in the group but not selected as the center point or are not included in the subgroup formed in operation 1050.

The present disclosure may assign the grid-based index to each of the points included in the point cloud data, may identify the eight points adjacent to the center point according to the grid-based index, and may perform clustering by measuring only the distance between the identified points and the center point, thereby reducing computational complexity compared to a conventional clustering method of performing clustering by measuring the distance between all points included in the point cloud data and the center point.

In addition, the clustering apparatus or clustering method according to the present disclosure may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read-only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific embodiments, the details should not be construed as limiting any disclosure or a scope that may be claimed, but rather should be construed as being descriptions of features that may be peculiar to specific embodiments of specific disclosures. Specific features described in the present specification in the context of individual embodiments may be combined and implemented in a single embodiment. On the contrary, various features described in the context of a single embodiment may be implemented in a plurality of embodiments individually or in any appropriate sub-combination. Moreover, although features may be described above as acting in specific combinations and even initially claimed as such, one or more features from a claimed combination can in some cases be excised from the combination, and the claimed combination may be changed to a sub-combination or a modification of a sub-combination.

Likewise, although operations are depicted in a predetermined order in the drawings, it should not be construed that the operations need to be performed sequentially or in the predetermined order, which is illustrated to obtain a desirable result, or that all of the shown operations need to be performed. In specific cases, multitasking and parallel processing may be advantageous. In addition, it should not be construed that the separation of various device components of the aforementioned embodiments is required in all types of embodiments, and it should be understood that the described program components and devices are generally integrated as a single software product or packaged into a multiple-software product.

The embodiments disclosed in the present specification and the drawings are intended merely to present specific embodiments in order to aid in understanding of the present disclosure, but are not intended to limit the scope of the present disclosure. It will be apparent to one of ordinary skill in the art that various modifications based on the technical spirit of the present disclosure, as well as the disclosed embodiments, can be made.

What is claimed is:

1. A clustering method comprising:
obtaining point cloud data of a light detection and ranging (LiDAR);
assigning a grid-based index to each of points included in the point cloud data; and
performing density-based clustering on the point cloud data based on the grid-based index.

2. The clustering method of claim 1, wherein
the performing of the density-based clustering comprises:
selecting an arbitrary center point from among the points included in the point cloud data;
identifying eight points adjacent to the arbitrary center point by using the grid-based index;
measuring a distance between the arbitrary center point and each of the eight points;
identifying a number of points among the eight points in which the measured distance is less than or equal to a threshold distance;
when the identified number of points exceeds a threshold number, forming a group including points in which the distance is less than or equal to the threshold distance and the arbitrary center point; and
clustering an inner portion of the group.

3. The clustering method of claim 2, wherein
the performing of the density-based clustering further comprises:
when the identified number of points is less than or equal to the threshold number, selecting another point as an arbitrary center point from among the points included in the point cloud data.

4. The clustering method of claim 2, wherein
the performing of the density-based clustering further comprises:
confirming whether the center point included in the group is also included in another group; and
when the center point included in the group is also included in the other group, merging the group with the other group.

5. A clustering apparatus comprising:
an inputter configured to obtain point cloud data of a light detection and ranging (LiDAR); and
a processor configured to assign a grid-based index to each of points included in the point cloud data and perform density-based clustering on the point cloud data based on the grid-based index.
